(19) United States
(12) Patent Application Publication
(10) Pub. No.: US 2016/0282747 A1
(43) Pub. Date: Sep. 29, 2016

(54) RECORDING MEDIUM PROCESSOR, IMAGE FORMING APPARATUS, AND IMAGE FORMING SYSTEM

(71) Applicant: Konica Minolta, Inc., Tokyo (JP)

(72) Inventor: Tsuyoshi TSUCHIYA, Tokyo (JP)

(21) Appl. No.: 15/079,606

(22) Filed: Mar. 24, 2016

(30) Foreign Application Priority Data
Mar. 26, 2015 (JP) 2015-064231

(51) Int. Cl. G03G 15/20

(52) U.S. Cl. CPC G03G 15/0266; G03G 15/6582

(57) ABSTRACT

A recording medium processor includes a charge neutralizing unit and a moisturizing unit. The charge neutralizing unit provides, to a charged recording medium, neutralizing charge having a polarity different from a polarity of charge on the recording medium. The moisturizing unit moisturizes the recording medium having the neutralizing charge provided by the charge neutralizing unit.

### CROSS REFERENCE TO RELATED APPLICATIONS

The present invention claims priority under 35 U.S.C. §119 to Japanese Application No. 2015-064231 filed Mar. 26, 2015, the entire content of which is incorporated herein by reference.

### BACKGROUND OF THE INVENTION

1. Field of the Invention

The present invention relates to a recording medium processor, an image forming apparatus, and an image forming system.

2. Description of Related Art

An electrophotographic image forming apparatus has been known that forms an image on the surface of a photoreceptor drum with charged toners and transfers the toners to a recording medium, such as paper, from the photoreceptor drum (or from an intermediate transfer member with toners having thereon that have been transferred from the photoreceptor drum), thereby forming an image on the recording medium. The transfer of the toners to the recording medium is carried out by application of a predetermined transfer voltage to the toners and to the recording medium for the toners to be attracted to the recording medium.

Such an image forming apparatus sometimes causes recording media to be charged due to the application of the transfer voltage and due to the static electricity generated when the recording media are conveyed. The charge may cause stacked recording media to stick to or repel each other, causing displacement of one or more of the stacked recording media.

Japanese Unexamined Patent Application Publication No. 2008-24379 discloses a technique for removing charge on a recording medium by making the recording medium pass between two plate moisturizing members to moisturize the recording medium.

Unfortunately, a recording medium may not absorb water enough depending on the material of the recording medium and the size of an image formed on the recording medium. For example, a sheet of coated paper with a low hydrophilic property and a recording medium having an image formed thereon at a high image coverage rate may not absorb moisture enough. In such a case, a recording medium to which moisture has been applied cannot hold the moisture sufficiently, and the application of moisture cannot remove charge sufficiently. The conventional technique thus may not be able to remove charge enough even by the application of moisture to recording media.

### SUMMARY OF THE INVENTION

An object of the present invention is to provide a recording medium processor, an image forming apparatus, and an image forming system that can surely reduce the amount of charge on recording media.

In order to achieve the object, a recording medium processor reflecting one aspect of the present invention includes: a charge neutralizing unit which provides, to a charged recording medium, neutralizing charge having a polarity different from a polarity of charge on the recording medium; and a moisturizing unit which moisturizes the recording medium having the neutralizing charge provided by the charge neutralizing unit.

Preferably, the recording medium processor further including a charge neutralizing controller which controls a polarity and amount of the neutralizing charge to be provided to the recording medium by the charge neutralizing unit based on at least one of a type of the recording medium and a mode of an image formed on the recording medium.

Preferably, in the recording medium processor, the charge neutralizing unit includes a pair of voltage applying rollers which conveys the recording medium while holding the recording medium therebetween and applies a predetermined voltage to the recording medium to provide the neutralizing charge to the recording medium.

Preferably, the recording medium processor further including a voltage applying controller which controls a polarity and level of the voltage to be applied by the voltage applying rollers to the recording medium based on at least one of a type of the recording medium and a mode of an image formed on the recording medium.

Preferably, the recording medium processor further including a moisturizing controller, wherein the moisturizing unit includes: a pair of conveying rollers which conveys the recording medium while holding the recording medium therebetween, and a water-supply unit which supplies water to outer peripheries of the conveying rollers; and wherein the moisturizing controller allows the water-supply unit to supply the water to the outer peripheries of the conveying rollers and allows the conveying rollers having the water on the outer peripheries thereof to convey the recording medium, thereby moisturizing the recording medium.

Preferably, in the recording medium processor, the moisturizing controller controls an amount of the water to be applied to the recording medium by the conveying rollers based on at least one of a type of the recording medium, a basis weight of the recording medium, and a mode of an image formed on the recording medium.

In order to achieve the object, an image forming apparatus reflecting another aspect of the present invention includes: an image forming unit which forms an image on a recording medium; and the recording medium processor which performs a predetermined process on the recording medium that has been charged and that has the image formed thereon by the image forming unit.

In order to achieve the object, an image forming system reflecting another aspect of the present invention includes: an image forming apparatus which forms an image on a recording medium; and a recording medium processor which performs a predetermined process on the recording medium that has been charged and that has the image formed thereon by the image forming apparatus, wherein the recording medium processor includes: a charge neutralizing unit which provides, to the recording medium, neutralizing charge having a polarity different from a polarity of charge on the recording medium, and a moisturizing unit which moisturizes the recording medium having the neutralizing charge provided by the charge neutralizing unit.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a diagram of an image forming system;

FIG. 2 is a block diagram showing main functional components of an image forming apparatus and a first finisher;

FIG. 3 is a schematic depiction of the configuration of a charge neutralizing unit, a moisturizing unit, and a conveying unit;

FIGS. 4A to 4E are schematic cross-sectional diagrams showing the state of charge on paper during a charge neutralizing process and a moisturizing process;

FIG. 5 shows the results of an experiment conducted to confirm the efficacy of an embodiment; and

FIG. 6 is a block diagram showing main functional components of an image forming apparatus according to a variation.

### DESCRIPTION OF THE PREFERRED EMBODIMENTS

A recording medium processor, an image forming apparatus, and an image forming system according to an embodiment of the present invention will now be described with reference to the drawings.

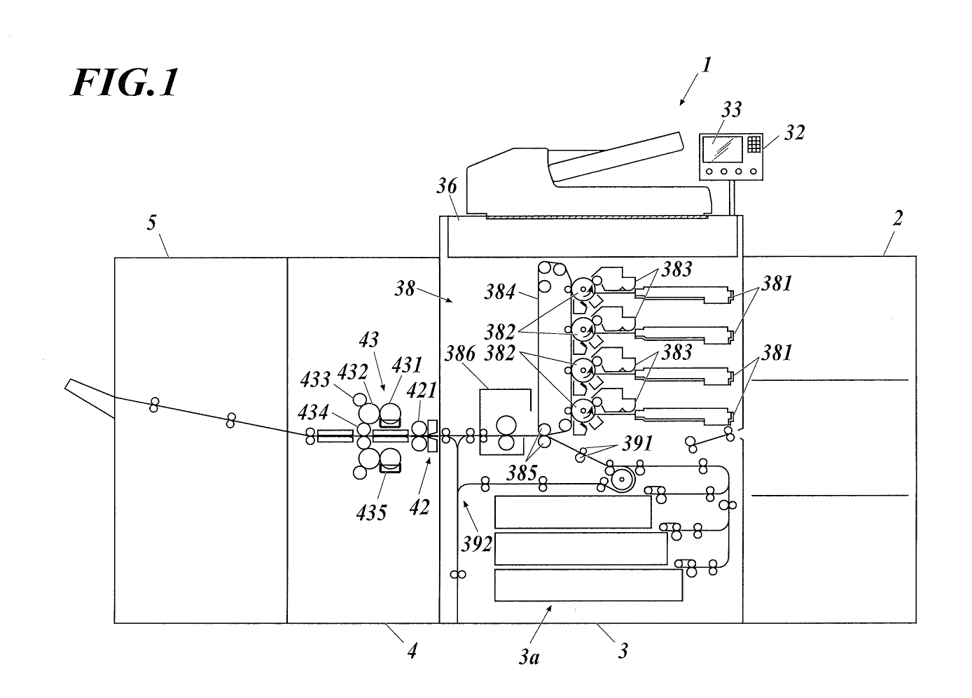

FIG. 1 is a diagram of an image forming system 1 according to an embodiment of the present invention.

The image forming system 1 includes a paper feeding apparatus 2, an image forming apparatus 3, a first finisher 4 (recording medium processor), and a second finisher 5.

The paper feeding apparatus 2 includes a plurality of large paper storages to store multiple sheets of paper (flat sheets of paper) as recording media. The paper feeding apparatus 2 conveys paper to the image forming apparatus 3 from a paper storage designated by the image forming apparatus 3.

The image forming apparatus 3 forms an image on paper in an electrophotographic method. The image forming apparatus 3 conveys paper, on which an image has been formed, to the first finisher 4.

The first finisher 4 performs a charge neutralizing process and a moisturizing process, which are described later, on paper that has been delivered from the image forming apparatus 3. The first finisher 4 conveys, to the second finisher 5, paper on which these processes have been performed.

The second finisher 5 performs predetermined finishing on paper that has been delivered from the first finisher 4 and ejects the paper. Examples of the finishing include decurling, stapling, punching, folding, and binding.

Each of the paper feeding apparatus 2, the image forming apparatus 3, the first finisher 4, and the second finisher 5 is detachably connected to the adjacent one.

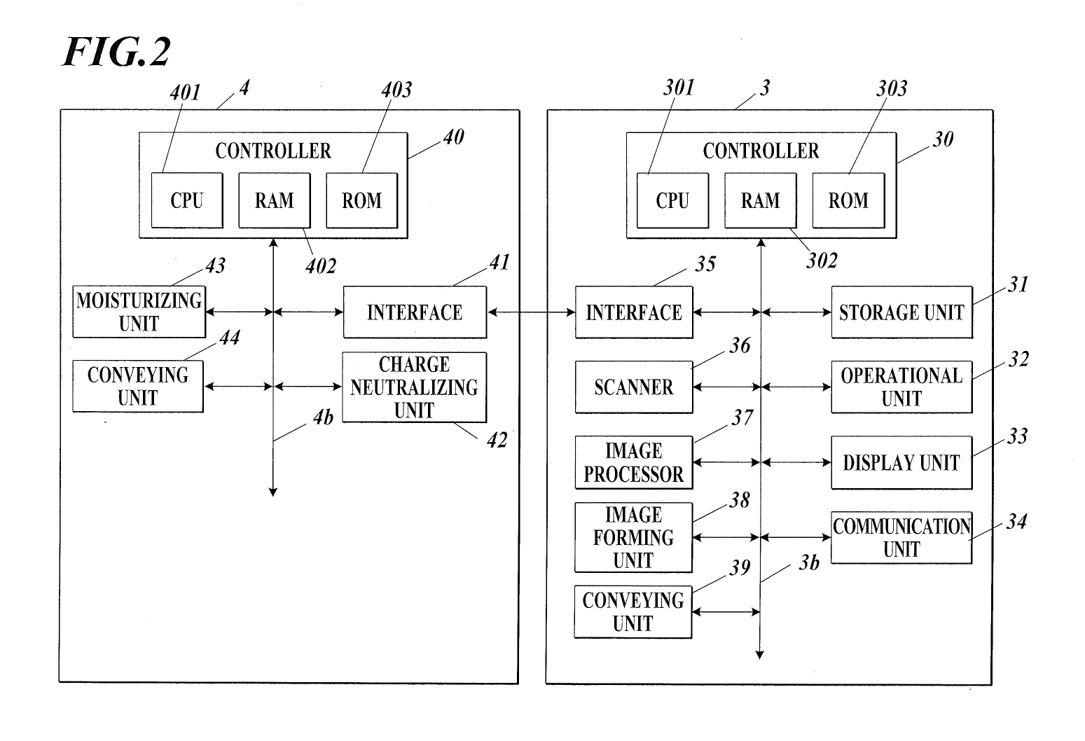

FIG. 2 is a block diagram showing main functional components of the image forming apparatus 3 and the first finisher 4.

The image forming apparatus 3 includes a controller 30 including a central processing unit (CPU) 301, a random access memory (RAM) 302, and a read only memory (ROM) 303; a storage unit 31; an operational unit 32; a display unit 33; a communication unit 34; an interface 35; a scanner 36; an image processor 37; an image forming unit 38; and a conveying unit 39. The controller 30 is connected to the storage unit 31, the operational unit 32, the display unit 33, the communication unit 34, the interface 35, the scanner 36, the image processor 37, the image forming unit 38, and the conveying unit 39 with a bus 3b.

The CPU 301 reads and executes controlling programs stored in the ROM 303 or the storage unit 31 to perform various types of arithmetic processing.

The RAM 302 provides the CPU 301 with a work memory area and stores temporary data.

The ROM 303 stores various controlling programs to be executed by the CPU 301 and various types of setting data. A rewritable non-volatile memory, such as an electrically erasable programmable read only memory (EEPROM) or a flash memory, may be used instead of the ROM 303.

The controller 30, which includes the CPU 301, the RAM 302, and the ROM 303, comprehensively controls the components of the image forming apparatus 3 in accordance with the controlling programs described above. For example, the controller 30 controls the image processor 37 to perform predetermined image processing on image data, and controls the storage unit 31 to store the processed image data. Further, the controller 30 controls the conveying unit 39 to convey paper and controls the image forming unit 38 to form an image on paper based on image data stored in the storage unit 31.

The storage unit 31 is composed of, for example, a dynamic random access memory (DRAM) and stores, for example, image data obtained from the scanner 36 and image data received from an external device via the communication unit 34. The image data may be stored in the RAM 302.

The operational unit 32 includes input devices such as operational keys and/or a touch panel laid on the screen of the display unit 33. The operational unit 32 converts input operations on the input devices into operational signals and outputs the signals to the controller 30.

The display unit 33, which includes a display such as a liquid crystal display (LCD), displays the status of the image forming system 1 and operational screens showing the contents corresponding to the input operations on the touch panel.

The communication unit 34 communicates with computers and other image forming apparatuses over a network to transmit and receive image data in accordance with control signals from the controller 30.

The interface 35, which may be composed of any one of various types of serial interfaces, transmits and receives data to and from the first finisher 4.

The scanner 36 scans an image formed on paper and creates image data including single-color image data of each of the color components of red (R), green (G), and blue (B). The scanner 36 sends the created image data to the storage unit 31, where the image data is stored.

The image processor 37 includes a rasterizer, a color converting section, a tone correcting section, and a halftone processor. The image processor 37 performs various types of image processing on the image data stored in the storage unit 31 and sends the processed image data to the storage unit 31, where the processed image data is stored.

The rasterizer converts vector image data, which is described in a predetermined page-description language (PDL) and is inputted from, for example, a computer over the network, into raster image data such as bitmap image data. The image data created through the conversion by the rasterizer includes single-color image data of each of the color components of cyan (C), magenta (M), yellow (Y), and black (K).

The color converting section performs color conversion of RGB image data outputted from the scanner 36 with reference to a predetermined look-up table and creates image data including single-color image data of each of C, M, Y, and K colors. The color converting section further performs predetermined color correction on the image data.

The tone correcting section corrects the tone values of image data by reference to a look-up table having predetermined correction values corresponding to tone values, so that the image of the image data has given tone characteristics.

The halftone processor performs halftone processing on image data such as screen processing and error diffusion processing with Dither matrix.

A part of or all of the functions of the rasterizer, the color converting section, the tone correcting section, and the halftone processor included in the image processor 37 may be performed by the controller 30 or by another image processing device disposed outside the image forming apparatus 3.

The image forming unit 38 forms an image on paper based on image data stored in the storage unit 31. The image forming unit 38 includes four sets for the CMYK color components, each set including an exposing section 381, a photoreceptor 382, and a developing section 383. The image forming unit 38 further includes a transfer member 384, secondary transfer rollers 385, and a fixing section 386.

The exposing section 381 includes a laser diode (LD) as a light-emitting element. The exposing section 381 drives the LD based on image data to irradiate and expose the charged photoreceptor 382 to laser light to form an electrostatic latent image on the photoreceptor 382. The developing section 383 supplies a toner (color material) of a color (any of CMYK) to the exposed photoreceptor 382 with a charged developing roller to develop the electrostatic latent image on the photoreceptor 382.

Images (single-color images) formed with the CMYK toners on the four photoreceptors 382 for C, M, Y, and K are transferred from the photoreceptors 382 to the transfer member 384 to be superposed on top of another sequentially. In this way, a color image composed of CMYK color components is formed on the transfer member 384. The transfer member 384 is an endless belt stretched around multiple transfer member movement rollers and rotates with the rotation of the transfer member movement rollers.

The secondary transfer rollers 385 transfer a color image from the transfer member 384 to paper fed from the paper feeding apparatus 2 or a paper feed tray 3a. More specifically, a predetermined voltage for transfer is applied to the secondary transfer rollers 385 that are holding paper and the transfer member 384 therebetween, so that the toners forming the color image on the transfer member 384 are attracted to and transferred to the paper.

The fixing section 386 fixes toners onto paper by heating and pressurizing the paper having the toners thereon. The fixing section 386 includes a pair of rollers (heat roller and pressure roller) to hold paper therebetween. The heat roller is heated to a predetermined target temperature (e.g., not less than 180° C. and not more than 200° C.) by a heater as a heat source. The pressure roller is biased toward the heat roller by an elastic member (not shown). Toner images that have been transferred onto paper at the secondary transfer rollers 385 are fixed to the paper by the paper's passing through the nip part between the heat roller and the pressure roller.

The conveying unit 39 includes multiple pairs of paper conveying rollers that rotate while holding paper therebetween to convey the paper along a predetermined conveyance path. The conveying unit 39 includes registration rollers 391 disposed upstream of the secondary transfer rollers 385 in the conveyance direction. The registration rollers 391 stop the conveyance of supplied paper and adjust the timings of sending the paper to the secondary transfer rollers 385. The conveying unit 39 includes an inversion mechanism 392 that turns over paper on which the fixing process has been performed by the fixing section 386, and conveys the turned-over paper to the secondary transfer rollers 385. The inversion mechanism 392 turns over a sheet of paper when the image forming apparatus 3 forms images on both sides of the sheet; whereas a sheet of paper is conveyed to the first finisher 4 without being turned over by the inversion mechanism 392 when the image forming apparatus 3 forms an image on only one side of the sheet.

The first finisher 4 includes a controller 40 (charge neutralizing controller, voltage applying controller, and moisturizing controller) including a CPU 401, a RAM 402, and a ROM 403; an interface 41; a charge neutralizing unit 42; a moisturizing unit 43; and a conveying unit 44. The controller 40 is connected to the interface 41, the charge neutralizing unit 42, the moisturizing unit 43, and the conveying unit 44 with a bus 4b.

The CPU 401 reads and executes controlling programs stored in the ROM 403 to perform various types of arithmetic processing.

The RAM 402 provides the CPU 401 with a work memory area and stores temporary data. The temporary data includes setting values relating to a charge neutralizing process and a moisturizing process, which are described later.

The ROM 403 stores various controlling programs to be executed by the CPU 401 and various types of setting data. A rewritable non-volatile memory, such as an EEPROM or a flash memory, may be used instead of the ROM 403. The setting data includes a look-up table to determine the polarity and level of a voltage to be applied during the charge neutralizing process and includes a look-up table to determine the amount of water to be supplied to paper during the moisturizing process, described later.

The controller 40, which includes the CPU 401, the RAM 402, and the ROM 403, comprehensively controls the components of the first finisher 4 in accordance with the controlling programs described above. For example, the controller 40 controls the charge neutralizing unit 42 to perform the process of neutralizing charge on paper under conditions indicated by the setting values stored in the RAM 402. Further, the controller 40 controls the moisturizing unit 43 to moisturize paper under conditions indicated by the setting values stored in the RAM 402.

The interface 41, which may be composed of any one of various types of serial interfaces, transmits and receives data to and from the image forming apparatus 3.

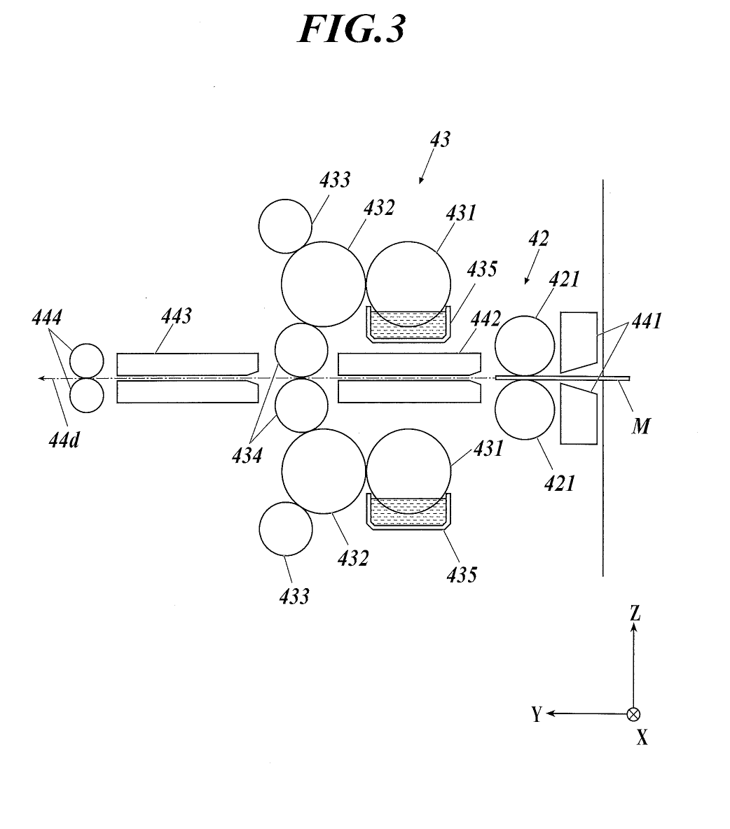

FIG. 3 is a schematic depiction of the configuration of the charge neutralizing unit 42, the moisturizing unit 43, and the conveying unit 44.

The charge neutralizing unit 42 includes a pair of voltage applying rollers 421. The voltage applying rollers 421 hold therebetween paper M delivered from the image forming apparatus 3 and guided by the guides 441. The voltage applying rollers 421 rotate while holding the paper M therebetween, thereby conveying the paper M along a predetermined conveyance path 44d. FIG. 3 defines the direction of the conveyance path 44d (i.e., the conveyance direction) as a Y direction. Each of the voltage applying rollers 421 is a cylindrical member that rotates about a rotation axis extending in the width direction (i.e., X direction) perpendicular to the conveyance direction of paper M. The outer periphery of each voltage applying roller 421 to come into contact with paper M is made of ion-conductive material. The ion-conductive material is a conductor having ions as charge carriers. In this embodiment, the outer periphery of each voltage applying roller 421 is composed of ion-conductive acrylonitrilebutadiene rubber (NBR). The outer periphery of each voltage applying roller 421 may be composed of electrically-conductive material other than ion-conductive material, such as metal. Each voltage applying roller 421 is connected to a power source (not shown). Alternatively, one of the voltage applying rollers 421 may be grounded and the other may be connected to a power source. The voltage applying rollers 421 perform a charge neutralizing process in which the rollers 421 neutralize at least part of charge on paper M held between the rollers 421 by applying a predetermined voltage to the paper M. The term “charge” refers to positively or negatively charged particles, which include electrons and ions. The voltage applying rollers 421 provide positive or negative charge to paper M during the charge neutralizing process. The charge neutralizing process is described in detail later.

The moisturizing unit 43 includes two first water-supply rollers 431 disposed on upper and lower sides of the conveyance path 44d, two second water-supply rollers 432 (water-supply unit) in contact with the respective outer peripheries of the two first water-supply rollers 431, two blading rollers 433 to be in contact with the respective outer peripheries of the two second water-supply rollers 432, a pair of moisturizing rollers 434 (conveying rollers) that is in contact with the respective outer peripheries of the two second water-supply rollers 432 and that holds paper M between the rollers 434, and two water reservoirs 435 to supply water to the two respective first water-supply rollers 431. The first water-supply rollers 431, the second water-supply rollers 432, and the moisturizing rollers 434 are each a cylindrical member that rotates about a rotation axis extending in the X direction and have outer peripheries with the same width in the X direction. The first water-supply rollers 431, the second water-supply rollers 432, and the moisturizing rollers 434 can hold water on their outer peripheries. Examples of material for the outer peripheries that can hold water include hydrophilic resin (e.g., NBR).

Each of the first water-supply rollers 431 is disposed in such a way that a part of the outer periphery of the roller 431 is in the water in the water reservoir 435. The outer peripheries of the first water-supply rollers 431 are in contact with the outer peripheries of the second water-supply rollers 432. The first water-supply rollers 431 rotate about their respective rotation axes to bring up the water from the water reservoirs 435 and hold the water with their outer peripheries. The first water-supply rollers 431 supply the water to the outer peripheries of the second water-supply rollers 432.

Each of the blading rollers 433 has an outer periphery at a predetermined distance from the outer periphery of the corresponding second water-supply roller 432. The outer periphery of each blading roller 433 moves relative to the outer periphery of the corresponding second water-supply roller 432, so as to remove excess water from the outer periphery of the second water-supply roller 432. The amount of water held by each second water-supply roller 432 can be adjusted by changing the distance between the outer periphery of the corresponding blading roller 433 and the outer periphery of the second water-supply roller 432.

The outer peripheries of the second water-supply rollers 432 are in contact with the outer peripheries of the moisturizing rollers 434. The second water-supply rollers 432 supply water to the outer peripheries of the moisturizing rollers 434 while both the rollers 432 and 434 are rotating.

The water-supply mechanism, which is composed of a water reservoir 435, a first water-supply roller 431, a second water-supply roller 432, and a blading roller 433, is disposed on each side (+Z side and −Z side) of the conveyance path 44d in the Z direction in FIG. 3. The moisturizing roller 434 on the +Z side receives water from the water-supply mechanism on the +Z side, and the moisturizing roller 434 on the −Z side receives water from the water-supply mechanism on the −Z side.

The outer periphery of each moisturizing roller 434 has an X-direction width larger than that of paper M. The moisturizing rollers 434 hold therebetween paper M which has been outputted from the charge neutralizing unit 42 and guided by the guides 442, and rotate while holding the paper M therebetween, thereby conveying the paper M. The moisturizing rollers 434 perform a moisturizing process in which the moisturizing rollers 434 apply water held by their respective outer peripheries to paper M to moisturize the paper M through conveying the paper M. The moisturizing process will be described in detail later. The distance between the outer peripheries of the moisturizing rollers 434 can be changed. The amount of water to be applied to paper M can be adjusted by changing the distance between the outer peripheries of the moisturizing rollers 434. For example, an increase in the distance between the outer peripheries increases the amount of water to be applied to paper M.

The conveying unit 44 includes the guides 441, 442, and 443 to guide paper M; and paper conveying rollers 444 that rotate while holding paper M therebetween, so as to convey the paper M along the conveyance path 44d.

The charge neutralizing process and the moisturizing process (predetermined process) performed in the first finisher 4 of the image forming system 1 will now be described. The charge neutralizing process and the moisturizing process are performed when, for example, paper M having an image formed thereon by the image forming apparatus 3 is delivered to the first finisher 4. The charge neutralizing process and the moisturizing process described below are performed under the control of the controller 40 of the first finisher 4.

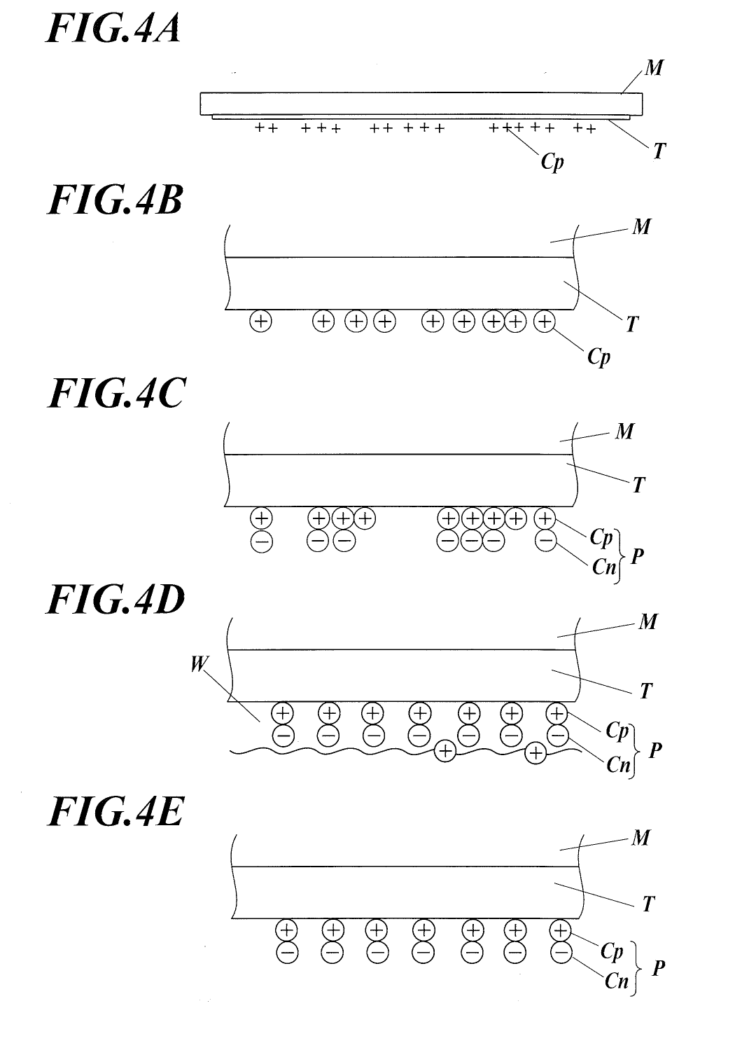

FIGS. 4A to 4E are schematic cross-sectional diagrams showing the state of charge on paper M during the charge neutralizing process and the moisturizing process.

FIG. 4A is a schematic cross-sectional diagram showing a sheet of paper M whose one face (hereinafter referred to as an “image-formation face”) has an image formed thereon by the image forming apparatus 3 through application and fixation of toner T. FIG. 4B is a schematic cross-sectional diagram showing the enlarged image-formation face of FIG. 4A. The paper M shown in FIGS. 4A and 4B has positive charge Cp on its image-formation face. The charge neutralizing process and the moisturizing process performed on the paper M shown in FIGS. 4A and 4B will now be described.

When the first finisher 4 receives the paper M shown in FIGS. 4A and 4B from the image forming apparatus 3, the charge neutralizing process is performed by the charge neutralizing unit 42. Specifically, the voltage applying rollers 421 convey the paper M while holding the paper M therebetween and apply a predetermined voltage to the paper M. In the voltage application in this embodiment, the potential at the voltage applying roller 421 in contact with the image-formation face of paper M is set to be lower than the potential at the voltage applying roller 421 in contact with the other face of the paper M.

As a result, charge (negative charge or neutralizing charge) Cn having a polarity opposite to that of the charge Cp is provided to the image-formation face of the paper M as shown in FIG. 4C. The charge Cn is, for example, the ions as charge carriers of the ion-conductive material composing the outer periphery of each voltage applying roller 421. The charge Cn provided to the paper M is coupled to the charge Cp on the image-formation face of the paper M to form charge pairs P. Part of the charge Cp remains on the image-formation face of the paper M without forming charge pairs P.

The charge pairs P are particles that are substantially not positively or negatively charged and that do not electrically interact with other charge. Paper M treated with the charge neutralizing process by the voltage applying rollers 421 may not have a uniform distribution of the charge pairs P, as shown in FIG. 4C.

In this way, through the charge neutralizing process, a major part of the charge Cp on paper M is coupled to supplied charge Cn to form charge pairs P, leading to significant reduction in the amount of charge Cp not forming charge pairs P on the paper M compared to before the charge neutralizing process.

In the charge neutralizing process described above, the polarity and level of the voltage to be applied to paper M by the voltage applying rollers 421 is determined with reference to a look-up table stored in the ROM 403 based on information indicating the type of paper M and the information relating to a mode of image formed on paper M. Examples of types of paper include coated paper having a coating on its surface and non-coated paper other than coated paper. Examples of information indicating a mode of formed image include the proportion (image coverage rate) of an image area in a sheet of paper M and whether one face or each face of a sheet of paper M is an image-formation face. The look-up table stored in the ROM 403 includes setting values representing the polarities and levels of the voltages to be applied appropriate for combinations of types of paper M and modes of formed images. For example, a larger level of voltage is set for coated paper M than for non-coated paper M. Further, a larger level of voltage is set for paper M whose image coverage rate is a predetermined value or more (e.g., 80% or more) than for paper M whose image coverage rate is less than the predetermined value. More specifically, the setting values are predetermined by forming images on different types of paper M in different modes and then obtaining appropriate polarities and levels of voltages based on the charge states of the sheets of paper M having the formed images.

The parameters to determine the polarity and level of voltage to be applied do not necessarily have to be a type of paper M and a mode of formed image but may be any one of a type of paper M and a mode of formed image. One or more parameters other than a type of paper M and a mode of formed image may be additionally or alternatively included.

In the charge neutralizing process at the charge neutralizing unit 42, the controller 40 obtains the information indicating the type of paper and the mode of formed image from the job information for instruction of the image formation inputted to the image forming apparatus 3. The controller 40 then refers to the look-up table stored in the ROM 403 based on the obtained information, obtains the setting values representing the polarity and level of voltage to be applied, and stores the obtained setting values in the RAM 402. The controller 40 then adjusts the polarity and level of the voltage to be applied to paper M by the voltage applying rollers 421 based on the setting values. The obtainment of the mode of formed image may be performed by the controller 40 analyzing the data obtained from a not-shown imaging unit, such as a linear sensor, picking up an image on paper M.

When the charge neutralizing process at the charge neutralizing unit 42 is over, the paper M is conveyed to the moisturizing unit 43, where the moisturizing process is performed on the paper M. Specifically, the paper M is conveyed while being held between the moisturizing rollers 434 during which water is applied to the surfaces of the paper M from the outer peripheries of the moisturizing rollers 434, thereby moisturizing the paper M. The water in the water reservoirs 435 is supplied to the outer peripheries of the moisturizing rollers 434 through the first water-supply rollers 431 and the second water-supply rollers 432 in advance of the moisturizing process. At the beginning of the moisturizing process, the outer peripheries of the moisturizing rollers 434 have already held the water.

FIG. 4D is a schematic cross-sectional diagram showing an enlarged image-formation face of paper M having moisture W in its surface. FIG. 4E is a schematic cross-sectional diagram showing an enlarged image-formation face of paper M after the evaporation of the moisture W. Paper M having moisture W has an increased electrical conductivity, facilitating movement of charge Cp that does not form charge pairs P on the surface of the paper M. When the paper M comes into contact with the conducting bodies of the other components (e.g., the moisturizing rollers 434, the guides 443, and the paper conveying rollers 444) of the first finisher 4 in this state, the charge Cp moves to the components from the paper M. Accordingly, the amount of the charge Cp remaining on the image-formation face of the paper M without forming charge pairs P is reduced by the time the moisture W evaporates from the paper M. If the charge Cn provided during the charge neutralizing process remains on the paper M without forming charge pairs P, the charge Cn is also removed and reduces in amount similarly to the charge Cp.

Paper M having the moisture W not only allows the charge pairs P to easily move around on the surface of the paper M but also moves the charge pairs P to be disposed at substantially regular intervals as shown in FIG. 4D. Evaporation of the moisture W from the paper M from this state allows the paper M to be dried with the charge pairs P uniformly distributed on the paper M as shown in FIG. 4E. Uneven distribution of charge pairs P on paper M as shown in FIG. 4C causes sheets of paper M to stick to or repel from each other even if the sheets of paper M only have charge pairs P but do not have other charge. A uniform distribution of charge pairs P as shown in FIG. 4E can reduce such a problem.

The quantity of water to be supplied to paper M by the moisturizing rollers 434 during the moisturizing process descried above is determined by reference to the look-up table stored in the ROM 403 based on the information indicating the type and basis weight of paper M and the information relating to the mode of image formed on paper M. The look-up table stored in the ROM 403 includes setting values representing the water supply quantities appropriate for combinations of types of paper M, basis weights of paper M, and modes of formed images. For example, a larger water supply quantity is set for coated paper M than for non-coated paper M. Further, a larger water supply quantity is set for paper M whose image coverage rate is a predetermined value or more (e.g., 80% or more) than for paper M whose image coverage rate is less than the predetermined value. More specifically, the setting values are predetermined by obtaining water supply quantities required for paper M with different types, basis weights, and modes of formed images to have about the same moisture level.

The parameters to determine the water supply quantity do not necessarily have to be a type of paper M, a basis weight of paper M, and a mode of formed image but may be at least one of a type of paper M, a basis weight of paper M, and a mode of formed image. One or more parameters other than a type of paper M, a basis weight of paper M, and a mode of formed image may be additionally or alternatively included.

In the moisturizing process at the moisturizing unit 43, the controller 40 obtains the information indicating the type and basis weight of paper and the mode of formed image from the job information for instruction of the image formation inputted to the image forming apparatus 3. The controller 40 then refers to the look-up table stored in the ROM 403 based on the obtained information, obtains the setting value representing the water supply quantity, and stores the obtained setting value in the RAM 402. The controller 40 then adjusts the amount of water to be supplied to the paper M from the moisturizing rollers 434 by changing the distance between the second water-supply rollers 432 and the respective blading rollers 433 and changing the distance between the moisturizing rollers 434 based on the setting value.

An experiment conducted for confirming the efficacy of the embodiment described above will now be described.

The same image was formed on multiple sheets of paper M by the image forming apparatus 3. OK TOPCOATs (A3 size) having a basis weight of 157 g/m2 were used as paper M, and a single-color image (cyan image) was formed on the entire surfaces of both sides of each sheet of paper M.

Some of the sheets of paper M were treated with the charge neutralizing process by the charge neutralizing unit 42 and then were stacked without the moisturizing process by the moisturizing unit 43 (this stack of paper is referred to as paper group A). The others of the sheets of paper M were treated with the charge neutralizing process by the charge neutralizing unit 42 under the same conditions as those of the comparative example, then treated with the moisturizing process by the moisturizing unit 43, and then dried and stacked (this stack of paper is referred to as paper group B).

The sticking force between sheets of paper M was measured 10 minutes and 60 hours after the paper M had been stacked for each of the paper groups A and B. The sticking force was defined as a force, measured by a spring balance, for separating the topmost sheet upward from the rest of the stack of paper M of each of the paper groups A and B.

FIG. 5 shows the results of the experiment. In FIG. 5, the values of sticking force are shown in arbitrary units. As shown in FIG. 5, the sticking forces of the paper groups A and B 10 minutes after the sheets of paper M had been stacked were about 3.3 and 1.6, respectively. The sticking forces of the paper groups A and B 60 hours after the sheets of paper M had been stacked were about 5.2 and 3.3, respectively. The measurement results of both 10 minutes later and 60 hours later show that the sticking forces of the paper group B, which had been treated with the moisturizing process after the charge neutralizing process, were smaller than the sticking forces of the paper group A, which had been treated with only the charge neutralizing process. It was thus confirmed that performing the moisturizing process after the charge neutralizing process reduced the charge Cp remaining on the paper M and uniformized the distribution of charge pairs P on the paper M, thereby reducing the sticking force between sheets of paper M.

As described above, the first finisher 4 (recording medium processor) according to this embodiment includes the charge neutralizing unit 42 and the moisturizing unit 43. The charge neutralizing unit 42 provides, to charged paper M, neutralizing charge having a polarity different from the polarity of the charge on the paper M. The moisturizing unit 43 moisturizes the paper M having the neutralizing charge provided by the charge neutralizing unit 42. Such a configuration allows the neutralizing charge provided by the charge neutralizing unit 42 to couple to and neutralize the charge on the paper M, thereby reducing the amount of the charge on the paper M. Further, since the paper M moisturized by the moisturizing unit 43 after the charge neutralization has an increased electrical conductivity, the charge remaining to be neutralized on the paper M is removed from the paper M to another component of the first finisher 4 in contact with the paper M. In this way, the moisturizing process is performed after the charge neutralizing unit 42 reduces the amount of the charge on the paper M through the charge neutralization. Such a configuration allows the moisturizing process to sufficiently reduce the charge even with paper M that cannot easily hold moisture, such as coated paper M with a low hydrophilic property and paper M having an image formed thereon at a high image coverage rate. Further, the moisturization of paper M by the moisturizing unit 43 eliminates the uneven distribution of charge pairs P that have been formed through the neutralization on the paper M and achieves a uniform distribution of the charge pairs P. This can reduce the problems that would be caused by the uneven distribution of the charge pairs P, such as the sheets of paper M sticking to or repelling each other.

The first finisher 4 according to this embodiment further includes the controller 40 (charge neutralizing controller) which controls the polarity and amount of neutralizing charge to be provided to the paper M by the charge neutralizing unit 42 based on at least one of the type of paper M and the mode of image formed on paper M. Such a configuration enables supply of the neutralizing charge having a proper polarity in a proper amount for neutralizing the charge on paper M in accordance with the type of the paper M and/or the mode of image formed on the paper M. This leads to reduction in the amount of the charge on the paper M regardless of the type of the paper M and/or the mode of image formed on the paper M.

Further, the charge neutralizing unit 42 includes the pair of voltage applying rollers 421 which conveys paper M while holding the paper M therebetween and applies a voltage to the paper M to provide neutralizing charge to the paper M. Such a configuration allows the charge neutralizing unit 42 to perform conveyance of the paper M concurrently with the charge neutralizing process for reduction in the amount of the charge on the paper M, thereby achieving efficient processing of the paper M. Further, even if the charge pairs P formed through the neutralization by the voltage applying rollers 421 have an uneven distribution on the paper M, the moisturization of the paper M by the moisturizing unit 43 can eliminate the uneven distribution of the charge pairs P on the paper M and achieve uniform distribution of the charge pairs P. This can reduce the problems that would be caused by the uneven distribution of the charge pairs P, such as the sheets of paper M sticking to or repelling each other. Further, if the paper M is newly charged due to frictions generated while the paper M is conveyed by the voltage applying rollers 421 or other conveying means, the new charge can be removed from the paper M to another component of the first finisher 4 in contact with the paper M. This is because the paper M moisturized by the moisturizing unit 43 has an increased electrical conductivity.

Further, the first finisher 4 of this embodiment includes the controller 40 (voltage applying controller) which controls the polarity and level of the voltage to be applied to paper M by the voltage applying rollers 421 based on at least one of the type of paper M and the mode of image formed on paper M. Such a configuration enables application, to paper M, of a voltage having a polarity and level appropriate for neutralizing charge on the paper M in accordance with the type of the paper M and/or the mode of image formed on the paper M. This leads to reduction in the amount of the charge on the paper M regardless of the type of the paper M and/or the mode of image formed on the paper M.

Further, the first finisher 4 includes the moisturizing unit 43 including the pair of moisturizing rollers 434 (conveying rollers) which conveys paper M while holding the paper M therebetween, and the second water-supply rollers 432 (water-supply unit) which supply water to the outer peripheries of the moisturizing rollers 434; and the controller 40 (moisturizing controller) which allows the second water-supply rollers 432 to supply water to the outer peripheries of the moisturizing rollers 434 and allows the moisturizing rollers 434 having water on their respective outer peripheries to convey the paper M, thereby moisturizing the paper M. Such a configuration allows the moisturizing rollers 434 to easily moisturize the paper M through conveyance of the paper M. Further, such a configuration allows the moisturizing unit 43 to perform the conveyance of the paper M concurrently with the moisturization of the paper M, thereby achieving efficient processing of the paper M.

Further, the controller 40 (moisturizing controller) controls the amount of water to be applied to paper M by the moisturizing rollers 434 based on at least one of the type of paper M, the basis weight of paper M, and the mode of image formed on paper M. Such a configuration enables moisturization of paper M with an appropriate amount of water applied to the paper M according to the type of the paper M, the basis weight of the paper M, and/or the mode of image formed on the paper M, to remove the charge on the paper M and uniformize the distribution of charge pairs P. This can remove the charge on the paper M and achieve a uniform distribution of the charge pairs P on the paper M regardless of the type of the paper M, the basis weight of the paper M, and/or the mode of image formed on the paper M.

Further, the image forming system 1 according to this embodiment includes the image forming apparatus 3 which forms an image on paper M and the first finisher 4 (recording medium processor) which performs a predetermined process on charged paper M having the image formed thereon by the image forming apparatus 3. The first finisher 4 includes the charge neutralizing unit 42 which provides, to the paper M, neutralizing charge having a polarity different from the polarity of the charge on paper M, and the moisturizing unit 43 which moisturizes the paper M having neutralizing charge provided by the charge neutralizing unit 42. Such a configuration can surely reduce the amount of the charge on the paper M.

### (Variation)

A variation of the above-described embodiment will now be described.

An image forming system 1 of the variation is the same as the image forming system 1 of the above-described embodiment except that, in the variation, the configuration of the first finisher 4 of the above-described embodiment is included in an image forming apparatus 3.

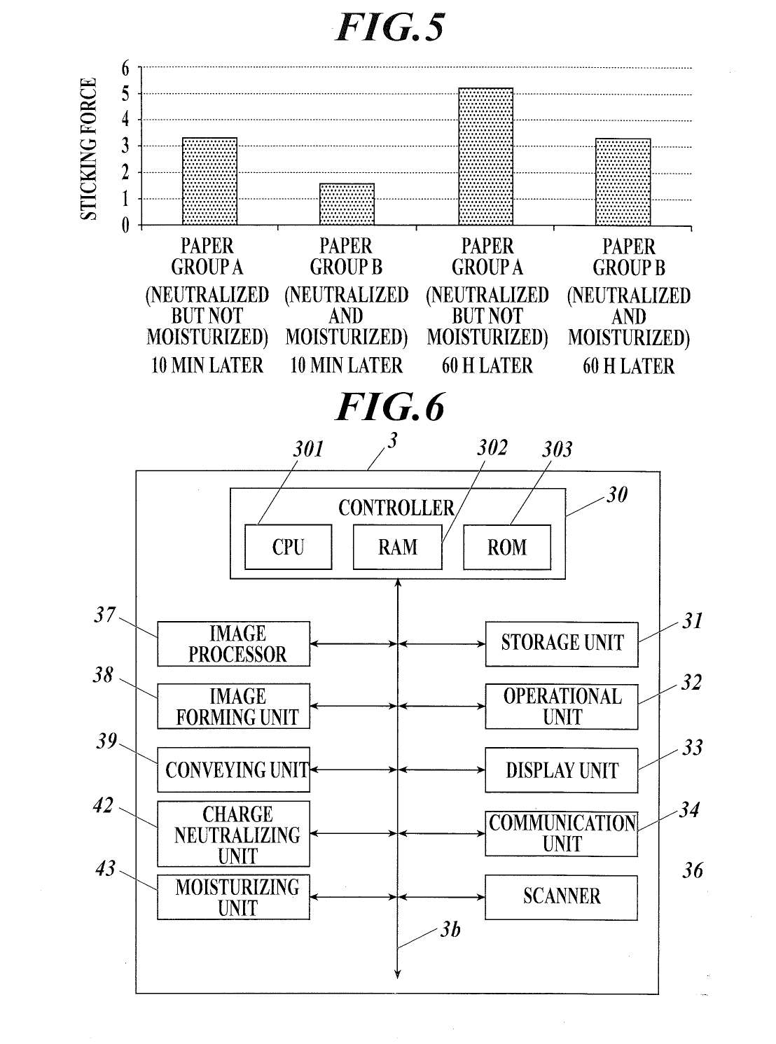

FIG. 6 is a block diagram showing main functional components of the image forming apparatus 3 according to the variation.

The image forming apparatus 3 of the variation includes a controller 30 including a CPU 301, a RAM 302, and a ROM 303; a storage unit 31; an operational unit 32; a display unit 33; a communication unit 34; a scanner 36; an image processor 37; an image forming unit 38; a conveying unit 39; a charge neutralizing unit 42; and a moisturizing unit 43. The components with the reference numerals identical to those of the above-described embodiment have the same configurations and functions as those of the above-described embodiment, and the detailed explanations thereof are omitted. The controller 30 of the variation has the configuration and function corresponding to those of the controller 40 of the first finisher 4 of the above-described embodiment, in addition to the same configuration and function as those of the controller 30 of the above-described embodiment. The conveying unit 39 of the variation has the configuration and function corresponding to those of the conveying unit 44 of the first finisher 4 of the above-described embodiment, in addition to the same configuration and function as those of the conveying unit 39 of the above-described embodiment.

In the above-described embodiment, the charge neutralizing process and the moisturizing process are performed on paper M by the first finisher 4; whereas, in the variation, these processes are performed by the image forming apparatus 3 under the control of the controller 30 of the image forming apparatus 3.

Only a part of the configuration of the first finisher 4 may be included in the image forming apparatus 3. For example, the configuration and function of only the controller 40 of the first finisher 4 may be included in the controller 30 of the image forming apparatus 3, in which case the scanning of paper M by the first finisher 4 may be performed under the control of the controller 30 of the image forming apparatus 3.

As seen above, the image forming apparatus 3 of the variation includes the image forming unit 38 which forms an image on paper M and the configuration corresponding to the first finisher 4 of the above-described embodiment to perform the charge neutralizing process and the moisturizing process on charged paper M having the image formed thereon by the image forming unit 38. Such a configuration allows the image forming apparatus 3 to surely reduce the amount of the charge on the paper M.

The present invention is not limited to the above-described embodiment and variation but may be modified in various manners.

For example, in the above-described embodiment and variation, the neutralization is performed by the voltage applying rollers 421 applying a voltage to paper M. However, the configuration to neutralize the charge on paper M is not limited to this. For example, paper M may be exposed to cations and/or anions as neutralizing charge generated by an ionizer for the neutralization. Alternatively, a voltage may be applied to paper M by a voltage applying unit having a configuration different from that of the voltage applying rollers 421. Examples of the voltage applying unit include a pair of electrode substrates disposed in such a way as to sandwich paper M.

In the above-described embodiment and variation, the moisturization of paper M is performed by the moisturizing rollers 434. However, the configuration to moisturize paper M is not limited to this. For example, a spray device that sprays water to paper M may be used to moisturize paper M.

In the above-described embodiment and variation, the charge neutralizing process and the moisturizing process are performed on paper M while the paper M is being conveyed by the voltage applying rollers 421 and the moisturizing rollers 434, respectively. Alternatively, the charge neutralizing process and the moisturizing process may be performed on paper M without involving conveyance of the paper M. For example, paper M disposed at a predetermined location may be neutralized with ions supplied by an ionizer and then may be moisturized by a spray device.

In the above-described embodiment and variation, the first finisher 4 processes paper M having an image formed thereon by the image forming apparatus 3. The present invention, however, is not limited to this. Alternatively, charged paper M may be directly sent to the first finisher 4 without the image forming apparatus 3, so that the charge neutralizing process and the moisturizing process are performed on the paper M in the first finisher 4.

In the above-described embodiment and variation, water is applied to paper M by the moisturizing unit 43 in the moisturizing process. Alternatively, water to be applied to paper M during the moisturizing process may contain electrolyte dissolved therein. Examples of the electrolyte include an anionic surfactant, a cationic surfactant, and an ampholytic surfactant.

In the above-described embodiment and variation, the charge neutralizing process and the moisturizing process are performed on paper M having an image formed on only one face of the paper M with toner T adhering and fixed thereto. The present invention, however, is not limited to this. Alternatively, the charge neutralizing process and the moisturizing process may be performed on paper M having images formed on its both faces. In the case of paper M having images on its both faces with one face having positive charge Cp and the other face having negative charge Cn, the voltage applying roller 421 on the one-face side may have a lower potential than the voltage applying roller 421 on the other-face side in application of voltage. Accordingly, negative charge Cn is provided to the one face and positive charge Cp is provided to the other face, leading to formation of charge pairs P on both faces of the paper M and thereby reducing the amount of charges on both faces of the paper M.

In the above-described embodiment and variation, the image forming apparatus 3 is an electrophotographic apparatus. The type of the image forming apparatus 3, however, is not limited to this. The image forming apparatus 3 may be an inkjet apparatus which ejects ink (color materials) from recording heads to a recording medium conveyed by a conveying device and forms an image by curing the ejected ink.

In the above-described embodiment and variation, the paper M used as recording media is in the form of flat sheets of paper (cut sheets of paper) having a predetermined length. Alternatively, a continuous form paper (roll paper) drawn out from a roll and wound around another roll may be used instead. Further, the recording medium is not limited to paper but may be any other medium on which color materials (e.g., toner or ink) can be fixed, such as a fabric and a sheet of resin.

In the above-described embodiment and variation, the first finisher 4 and the second finisher 5 are separate apparatuses that are connected to each other. Alternatively, the configuration and function of the second finisher 5 may be included in the first finisher 4. That is, the first finisher 4 may perform predetermined finishing, such as decurling, stapling, punching, folding, and binding, in addition to the charge neutralizing process and the moisturizing process. Any of the predetermined finishing, such as decurling, may be performed on paper M that has been moisturized by the moisturizing unit 43 if preliminary moisturization of the paper M is required.

The present invention is not limited to the embodiments described above but includes the scope of the claims and the equivalents thereof.

The entire disclosure of Japanese Patent Application No. 2015-064231 filed on Mar. 26, 2015 including description, claims, drawings, and abstract are incorporated herein by reference in its entirety.

Although various exemplary embodiments have been shown and described, the present invention is not limited to the embodiments shown. Therefore, the scope of the present invention is intended to be limited solely by the scope of the claims that follow.

What is claimed is:

1. A recording medium processor comprising:
a charge neutralizing unit which provides, to a charged recording medium, neutralizing charge having a polarity different from a polarity of charge on the recording medium; and
a moisturizing unit which moisturizes the recording medium having the neutralizing charge provided by the charge neutralizing unit.

2. The recording medium processor according to claim 1, further comprising a charge neutralizing controller which controls a polarity and amount of the neutralizing charge to be provided to the recording medium by the charge neutralizing unit based on at least one of a type of the recording medium and a mode of an image formed on the recording medium.

3. The recording medium processor according to claim 1, wherein the charge neutralizing unit comprises a pair of voltage applying rollers which conveys the recording medium while holding the recording medium therebetween and applies a predetermined voltage to the recording medium to provide the neutralizing charge to the recording medium.

4. The recording medium processor according to claim 3, further comprising a voltage applying controller which controls a polarity and level of the voltage to be applied by the voltage applying rollers to the recording medium based on at least one of a type of the recording medium and a mode of an image formed on the recording medium.

5. The recording medium processor according to claim 1, further comprising a moisturizing controller,
wherein the moisturizing unit comprises:
a pair of conveying rollers which conveys the recording medium while holding the recording medium therebetween, and
a water-supply unit which supplies water to outer peripheries of the conveying rollers; and
wherein the moisturizing controller allows the water-supply unit to supply the water to the outer peripheries of the conveying rollers and allows the conveying rollers having the water on the outer peripheries thereof to convey the recording medium, thereby moisturizing the recording medium.

6. The recording medium processor according to claim 5, wherein the moisturizing controller controls an amount of the water to be applied to the recording medium by the conveying rollers based on at least one of a type of the recording medium, a basis weight of the recording medium, and a mode of an image formed on the recording medium.

7. An image forming apparatus comprising:
an image forming unit which forms an image on a recording medium; and
the recording medium processor according to claim 1 which performs a predetermined process on the recording medium that has been charged and that has the image formed thereon by the image forming unit.

8. The image forming apparatus according to claim 7, further comprising a charge neutralizing controller which controls a polarity and amount of the neutralizing charge to be provided to the recording medium by the charge neutralizing unit based on at least one of a type of the recording medium and a mode of the image formed on the recording medium.

9. The image forming apparatus according to claim 7, wherein the charge neutralizing unit comprises a pair of voltage applying rollers which conveys the recording medium while holding the recording medium therebetween and applies a predetermined voltage to the recording medium to provide the neutralizing charge to the recording medium.

10. The image forming apparatus according to claim 9, further comprising a voltage applying controller which controls a polarity and level of the voltage to be applied by the voltage applying rollers to the recording medium based on at least one of a type of the recording medium and a mode of the image formed on the recording medium.

11. The image forming apparatus according to claim 7, further comprising a moisturizing controller,
wherein the moisturizing unit comprises:
a pair of conveying rollers which conveys the recording medium while holding the recording medium therebetween, and
a water-supply unit which supplies water to outer peripheries of the conveying rollers; and
wherein the moisturizing controller allows the water-supply unit to supply the water to the outer peripheries of the conveying rollers and allows the conveying rollers having the water on the outer peripheries thereof to convey the recording medium, thereby moisturizing the recording medium.

12. The image forming apparatus according to claim 11, wherein the moisturizing controller controls an amount of the water to be applied to the recording medium by the conveying rollers based on at least one of a type of the recording medium, a basis weight of the recording medium, and a mode of the image formed on the recording medium.

13. An image forming system comprising:
an image forming apparatus which forms an image on a recording medium; and
a recording medium processor which performs a predetermined process on the recording medium that has been charged and that has the image formed thereon by the image forming apparatus, wherein
the recording medium processor comprises:
a charge neutralizing unit which provides, to the recording medium, neutralizing charge having a polarity different from a polarity of charge on the recording medium, and
a moisturizing unit which moisturizes the recording medium having the neutralizing charge provided by the charge neutralizing unit.

14. The image forming system according to claim 13, further comprising a charge neutralizing controller which controls a polarity and amount of the neutralizing charge to be provided to the recording medium by the charge neutralizing unit based on at least one of a type of the recording medium and a mode of the image formed on the recording medium.

15. The image forming system according to claim 13, wherein the charge neutralizing unit comprises a pair of voltage applying rollers which conveys the recording medium while holding the recording medium therebetween and applies a predetermined voltage to the recording medium to provide the neutralizing charge to the recording medium.

16. The image forming system according to claim 15, further comprising a voltage applying controller which controls a polarity and level of the voltage to be applied by the voltage applying rollers to the recording medium based on at least one of a type of the recording medium and a mode of the image formed on the recording medium.

17. The image forming system according to claim 13, further comprising a moisturizing controller,
wherein the moisturizing unit comprises:
a pair of conveying rollers which conveys the recording medium while holding the recording medium therebetween, and
a water-supply unit which supplies water to outer peripheries of the conveying rollers; and
wherein the moisturizing controller allows the water-supply unit to supply the water to the outer peripheries of the conveying rollers and allows the conveying rollers having the water on the outer peripheries thereof to convey the recording medium, thereby moisturizing the recording medium.

18. The image forming system according to claim 17, wherein the moisturizing controller controls an amount of the water to be applied to the recording medium by the conveying rollers based on at least one of a type of the recording medium, a basis weight of the recording medium, and a mode of the image formed on the recording medium.
